(19) United States
(12) Patent Application Publication
(10) Pub. No.: US 2026/0296465 A1
(43) Pub. Date: Oct. 1, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventors: Toru Kokaki, Tokyo (JP); Daichi Kato, Tokyo (JP)

(21) Appl. No.: 19/544,075

(22) Filed: Feb. 19, 2026

(30) Foreign Application Priority Data
Mar. 31, 2025 (JP) 2025-058003

(51) Int. Cl. B60W 50/08; B60W 60/00

(52) U.S. Cl. CPC B60W 50/082; B60W 60/001; B60W 2540/215

(57) ABSTRACT

A travel control device starts travel control of a vehicle based on any one of a plurality of travel control modes including a first mode and a second mode that performs travel control having an automation level lower than the automation level of the first mode, by an operation on a start operation portion; determines a position of the vehicle in starting the travel control; and changes, in starting the travel control, a travel control mode to be executed when the travel control is started by an operation on the start operation portion according to a determination result of the position.

### CROSS-REFERENCE TO RELATED APPLICATION

Priority is claimed on Japanese Patent Application No. 2025-058003, filed Mar. 31, 2025, the content of which is incorporated herein by reference.

### BACKGROUND

### Field of the Invention

The present invention relates to a travel control device, a travel control method, and a storage medium.

### Description of Related Art

In recent years, there have been increasing attempts to provide access to a sustainable transportation system that takes into consideration the most vulnerable traffic participants. For this realization, research and development efforts are focused on further improving the safety and convenience of transportation through research and development related to automated driving technology.

In this connection, conventionally, a travel control device configured to execute a plurality of travel control modes in performing travel control of a vehicle is known. Further, in such a travel control device, a technique is known in which, each time an operator is operated, travel control modes to be executed are transitioned to in a predetermined order, thereby enabling a desired travel control mode to be selected and started by a single operator (for example, see Japanese Unexamined Patent Application, First Publication No. 2016-83990).

### SUMMARY

In conventional driving assistance technology, since a transition order of travel control modes with respect to the number of operations of an operator is fixed, in a case where the operator is operated in a state where travel control is not being executed, the same travel control mode is always started. Accordingly, in a case where an effective travel control mode differs depending on a scene (a position of a vehicle), it may be necessary to operate the operator a plurality of times until the effective travel control mode is started.

One of the objects of the present application is to provide a travel control device, a travel control method, and a storage medium that can easily start an effective travel control mode according to a scene. Further, the present application contributes to the development of a sustainable transportation system.

A travel control device of a first aspect of the present invention includes a storage medium storing computer-readable instructions; and one or more processors connected to the storage medium, the processor executing the computer-readable instructions to: start travel control of a vehicle based on any one of a plurality of travel control modes including a first mode and a second mode that performs travel control having an automation level lower than the automation level of the first mode, by an operation on a start operation portion, determine a position of the vehicle in starting the travel control, and change, in starting the travel control, a travel control mode to be executed when the travel control is started by an operation on the start operation portion according to a determination result of the position.

A second aspect is the travel control device according to the first aspect, in which the one or more processors may execute the computer-readable instructions to: in a case where the start operation portion is operated a plurality of times, execute, among the plurality of travel control modes, a travel control mode different from a travel control mode executed before the start operation portion is operated the plurality of times.

A third aspect is the travel control device according to the first aspect, in which the one or more processors may execute the computer-readable instructions to: in a case where whether the first mode or the second mode is to be preferentially executed is set by an occupant of the vehicle, preferentially execute the travel control mode set by the occupant regardless of the determination result.

A fourth aspect is the travel control device according to the first aspect, in which the one or more processors may execute the computer-readable instructions to: in a case where a travel control mode executable by the travel control unit is added by an update, preferentially execute the added travel control mode.

A fifth aspect is the travel control device according to the first aspect, in which the first mode may be a mode that performs travel control toward a destination, the second mode may be a mode that performs travel control without considering a destination, and the one or more processors may execute the computer-readable instructions to: in a state where a destination of the vehicle is set, execute the first mode by an operation on the start operation portion in a case where the position satisfies a predetermined condition, and execute the second mode by an operation on the start operation portion in a case where the position does not satisfy the predetermined condition.

A sixth aspect is the travel control device according to the fifth aspect, in which the one or more processors may execute the computer-readable instructions to: in a state where a destination of the vehicle is not set, execute the second mode regardless of the position.

A seventh aspect is the travel control device according to the first aspect, in which the first mode may be a mode that performs travel control toward a destination, the second mode may be a mode that performs travel control without considering a destination, the plurality of travel control modes may further include a third mode that has an automation level lower than the automation level of the first mode and higher than the automation level of the second mode and performs travel control without considering a destination, and the one or more processors may execute the computer-readable instructions to: execute the first mode by an operation on the start operation portion in a case where, in a state where a destination of the vehicle is set, the position satisfies a predetermined condition, execute the second mode by an operation on the start operation portion in a case where, in a state where the destination of the vehicle is set, the position does not satisfy the predetermined condition, and execute the third mode in a state where the destination of the vehicle is not set.

An eighth aspect is the travel control device according to the first aspect, in which the first mode may be a mode that performs travel control toward a destination, the second mode may be a mode that performs travel control without considering a destination, the plurality of travel control modes may further include a third mode that has an automation level higher than the automation level of the second mode and performs travel control without considering a destination, the third mode may be a mode that performs travel control along a route calculated such that, when the vehicle proceeds to a point at which a plurality of route candidates exist, the vehicle proceeds to a road determined based on a predetermined priority order among the plurality of route candidates, and the one or more processors may execute the computer-readable instructions to: execute the first mode by an operation on the start operation portion in a case where, in a state where a destination of the vehicle is set, the position satisfies a predetermined condition, execute the second mode by an operation on the start operation portion in a case where, in a state where the destination of the vehicle is set, the position does not satisfy the predetermined condition, and execute the third mode in a state where the destination of the vehicle is not set.

A ninth aspect is the travel control device according to the first aspect, in which the first mode may be a mode in which gripping of a steering wheel is not required for an occupant of the vehicle, and the second mode may be a mode in which gripping of the steering wheel is required for the occupant of the vehicle.

A travel control method according to a tenth aspect of the present invention is a travel control method executed by a computer, the travel control method including starting travel control of a vehicle based on any one of a plurality of travel control modes including a first mode and a second mode that performs travel control having an automation level lower than the automation level of the first mode, by an operation on a start operation portion, determining a position of the vehicle in starting the travel control, and changing, in starting the travel control, a travel control mode to be executed when the travel control is started by the operation on the start operation portion according to a determination result of the position.

An eleventh aspect of the present invention is a computer-readable non-transitory storage medium storing a program, the program causing a computer to start travel control of a vehicle based on any one of a plurality of travel control modes including a first mode and a second mode that performs travel control having an automation level lower than the automation level of the first mode, by an operation on a start operation portion, determine a position of the vehicle in starting the travel control, and change, in starting the travel control, a travel control mode to be executed when the travel control is started by the operation on the start operation portion according to a determination result of the position.

According to the first to eleventh aspects described above, an effective travel control mode according to a scene can be easily started.

### BRIEF DESCRIPTION OF THE DRAWINGS

FIG. 1 is a configuration diagram of a vehicle system including a travel control device according to an embodiment.

FIG. 2 is a functional configuration diagram of a switching control unit.

FIG. 3 is a functional configuration diagram of a first control unit.

FIG. 4 is a diagram illustrating an example of determination condition information.

FIG. 5 is a diagram for explaining travel scenes in which the first mode, the second mode, and the third mode are executable.

FIG. 6 is a flowchart illustrating an example of a flow of processing executed by a vehicle system.

### DESCRIPTION OF EMBODIMENTS

Hereinafter, embodiments of a travel control device, a travel control method, and a storage medium of the present invention will be described with reference to the drawings.

### Overall Configuration

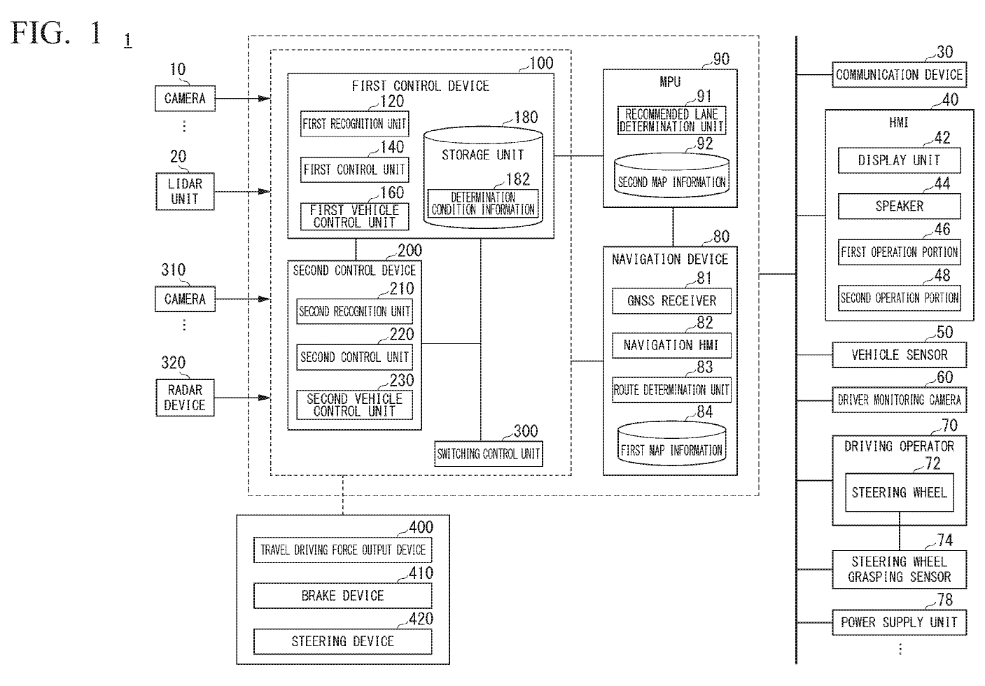

FIG. 1 is a configuration diagram of a vehicle system 1 including a travel control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor is operated using electric power generated by a generator connected to the internal combustion engine, or using discharged electric power from a secondary battery or a fuel cell. In the following description, a vehicle will be described as a four-wheeled hybrid vehicle having an internal combustion engine and an electric motor as driving sources.

The vehicle system 1 includes, for example, a camera 10, a light detection and ranging (LIDAR) unit 20, a communication device 30, a human machine interface (HMI) 40, a vehicle sensor 50, a driver monitoring camera 60, a driving operator 70, a steering wheel grasping sensor 74, a power supply unit 78, a navigation device 80, a map positioning unit (MPU) 90, and a first control device 100.

Further, the vehicle system 1 includes, for example, a second control device 200, a camera 310, a radar device 320, a travel driving force output device 400, a brake device 410, and a steering device 420. Further, the vehicle system 1 includes, for example, a switching control unit 300. The first control device 100, the second control device 200, the switching control unit 300, the human machine interface (HMI) 40, the driving operator 70, the navigation device 80, and the map positioning unit (MPU) 90 are examples of a “travel control device”. The first control device 100, the second control device 200, and a mode determination unit 306 (described later) included in the switching control unit 300 are examples of a “travel control unit”. The travel control unit in the embodiment performs travel control of a vehicle on which the vehicle system 1 is mounted (hereinafter, vehicle M). The travel control unit in the embodiment is configured to be capable of executing a plurality of travel control modes (details will be described later).

These devices and equipment are connected to each other by multiple communication lines, such as a control unit area network (CAN) communication line, serial communication lines, wireless communication networks, or the like. The configurations shown in FIGS. 1 and 2 and 3 to be described later are merely examples, and a part of the configuration may be omitted, or another configuration may be further added. Moreover, the functional configurations may be integrated or may be provided in a dispersed manner.

For example, the camera 10 is a digital camera using a solid-state imaging element such as, for example, a charge-coupled device (CCD) or a complementary metal oxide semiconductor (CMOS). The camera 10 is attached to any location on the vehicle M in which the vehicle system 1 is mounted. When capturing an image of the front, the camera 10 is attached to a front windshield upper portion, a rearview mirror back surface, or the like. The camera 10 captures images of the surroundings of the vehicle M repeatedly, for example, periodically. The camera 10 may also be a stereo camera.

The LIDAR unit 20 irradiates surroundings of the vehicle M with light (or electromagnetic waves having a wavelength close to that of light) and measures scattered light. The LIDAR unit 20 detects a distance to a target based on a time from light emission to light reception. The emitted light is, for example, a pulsed laser beam.

The LIDAR unit 20 may be attached at any location. However, a sensor portion of the LIDAR unit 20 is mounted, for example, at a position capable of acquiring surrounding information including information in front of the vehicle M, such as on a roof. The LIDAR unit 20 may be provided with an electronic control unit (ECU).

The communication device 30 communicates with other vehicles in the vicinity of the vehicle M using, for example, a cellular network, a Wi-Fi network, Bluetooth (registered trademark), dedicated short range communication (DSRC), etc., or communicates with various server devices via a wireless base station.

The HMI 40 presents various types of information to the occupant of the vehicle M and accepts input operations from the occupant. The HMI 40 includes, for example, a display unit 42, a speaker 44, a first operation portion 46, and a second operation portion 48. For example, the display unit 42 is a liquid crystal display (LCD), an electroluminescence (EL) display device, or the like. The display unit 42 is provided, for example, in an instrument panel or a meter display portion. The display unit 42 displays various types of images (including video) in the embodiment. The display unit 42 may be configured integrally with an input unit as a touch panel. The speaker 44 outputs predetermined sounds (for example, alarms) to a vehicle interior.

The first operation portion 46 receives an operation by an occupant for starting travel control by the travel control unit. The first operation portion 46 may be configured by, for example, a single operator. Examples of the operator include a button, a switch, a lever, a touch pad, and a track button. The first operation portion 46 is an example of a “start operation portion”. The second operation portion 48 may receive an operation for designating contents of travel control in each travel control mode, such as setting of parameters (for example, speed adjustment) in travel control being executed. The second operation portion 48 may include a single operator or a plurality of operators. The first operation portion 46 and the second operation portion 48 may be provided, for example, on a steering wheel 72, or may be provided on a touch panel of the display unit 42.

Further, in addition to the display unit 42, the speaker 44, the first operation portion 46, and the second operation portion 48, the HMI 40 may include a microphone, a buzzer, a vibration generation device (vibrator), keys, and the like. Further, the HMI 40 may include an output unit that prompts a driver to grip a steering wheel, and a head up display (HUD).

The vehicle sensor 50 includes various sensors used for control of the vehicle, such as a vehicle speed sensor for detecting a speed of the vehicle, an acceleration sensor for detecting acceleration, a yaw rate sensor for detecting an angular velocity around a vertical axis, and a direction sensor for detecting an orientation of the vehicle. In addition, the vehicle sensor 50 may be provided with a position sensor that detects the position of the vehicle M. The position sensor is, for example, a sensor that acquires position information (longitude and latitude information) from a global positioning system (GPS) device. Further, the position sensor may be a sensor that acquires position information using a global navigation satellite system (GNSS) receiver 81 of the navigation device 80.

The driver monitoring camera 60 is, for example, a digital camera that uses a solid-state imaging element such as a CCD or a CMOS. The driver monitoring camera 60 is attached at any location of the vehicle M at a position and an orientation that enable an image of a head of a driver seated in a driver’s seat of the vehicle M to be captured from the front (in a direction for capturing an image of the face). For example, the driver monitoring camera 60 is attached to an upper part of a display device which is provided at the center of the instrument panel of the vehicle M.

The driving operator 70 includes, for example, a steering wheel 72 as well as an accelerator pedal, a brake pedal, a shift lever, and other operators. A sensor for detecting an operation amount or presence or absence of an operation is attached to the driving operator 70, and detection results thereof are output to some or all of the first control device 100, the second control device 200, the switching control unit 300, or the travel driving force output device 400, the brake device 410, and the steering device 420.

The steering wheel 72 does not necessarily have an annular shape, and may be in a form of a deformed steering wheel, a joystick, a button, or the like. The steering

wheel grasping sensor 74 is attached to the steering wheel 72. The steering wheel grasping sensor 74 is implemented by, for example, a capacitive sensor, and outputs, to the first control device 100, the second control device 200, or the switching control unit 300, a signal capable of detecting whether a driver is gripping the steering wheel 72 (which means being in contact in a state in which a force can be applied). Further, the steering wheel 72 may be provided with the first operation portion 46 and the second operation portion 48.

The power supply unit 78 is a battery that supplies power to the vehicle system 1. The power supply unit 78 includes a plurality of batteries, and may be redundantly configured such that, in a case where a failure occurs in one of the batteries, power is supplied from the other battery.

The navigation device 80 includes, for example, a GNSS receiver 81, a navigation HMI 82, and a route determination unit 83. In the navigation device 80, first map information 84 is retained in a storage device such as a hard disk drive (HDD) or a flash memory. The GNSS receiver 81 specifies a position of the vehicle M based on the signal received from a GNSS satellite. The position of the vehicle M may be specified or supplemented by an inertial navigation system (INS) using the output of the vehicle sensor 50. The navigation HMI 82 includes a display device, a speaker, a touch panel, and keys. The navigation HMI 82 may be partially or completely shared with the HMI 40 described above. For example, the route determination unit 83 determines, with reference to first map information 84, a route (hereinafter, a route on a map) from a position of the vehicle M specified by the GNSS receiver 81 (or an arbitrary input position) to a destination input by an occupant using the navigation HMI 82. The first map information 84 is, for example, information that represents a shape of a road using links that indicate roads and nodes connected by the links. The first map information 84 may include point of interest (POI) information, and the like. The route on map is output to the MPU 90. The navigation device 80 may perform route guidance using the navigation HMI 82 based on the route on map. The navigation device 80 may be realized by, for example, a function of a terminal device such as a smartphone, a tablet terminal, or the like, owned by the occupant. The navigation device 80 may transmit the current position and destination to a navigation server via the communication device 30, and acquire the same route as the route on map from the navigation server.

The MPU 90 includes, for example, a recommended lane determination unit 91 and stores second map information 92 in a storage device such as an HDD or a flash memory. The recommended lane determination unit 91 divides the route on the map provided from the navigation device 80 into a plurality of blocks (e.g., divides the route every 100 [m] in a traveling direction of the vehicle), and decides a recommended lane for each block with reference to the second map information 92. The recommended lane determination unit 91 determines which lane from the left the vehicle travels on. When there is a branching point in the route on a map, the recommended lane determination unit 91 determines the recommended lane such that the vehicle M travels along a rational route for traveling to a branching destination. In addition, the MPU 90 recognizes the position of the vehicle M based on detection results of a gyro sensor (not shown), the position of the vehicle M specified by the GNSS receiver 81, and the like.

The second map information 92 is map information more accurate than the first map information 84. The second map information 92 includes, for example, information of a lane center, information of a lane boundary, or the like. In addition, the second map information 92 may include road information, traffic regulation information, address information (address and postal code), facility information, telephone number information, and the like. The road information may include, for example, road type information such as expressways and general roads, road shape information such as merging, branching, T-junctions, and curvature (or radius of curvature), and other road information such as the number of lanes, road gradient, a junction (JCT), service areas, toll gates, and a zebra zone (channelization zone). The second map information 92 may be updated at any time by the communication device 30 communicating with the external device.

The travel driving force output device 400 outputs a traveling driving force (torque) to the driving wheels so that the vehicle M travels. The travel driving force output device 400 includes, for example, a combination of an internal combustion engine, an electric motor, and a transmission, and an ECU that controls these. The ECU controls the above-described configuration in accordance with information input from the first control device 100 or the second control device 200, or information input from an accelerator pedal of the driving operator 70.

The brake device 410 includes, for example, a brake caliper, a cylinder that transmits a hydraulic pressure to the brake caliper, an electric motor that generates the hydraulic pressure in the cylinder, and a brake ECU. The brake ECU controls an electric motor in accordance with information input from the first control device 100 or the second control device 200, or information input from a brake pedal of the driving operator 70, such that brake torque according to a braking operation is output to each wheel. The brake device 410 may include, as a backup, a mechanism for transferring a hydraulic pressure generated by an operation of a brake pedal to the cylinder via a master cylinder. Note that the brake device 410 is not limited to the configuration described above, and may be an electronically controlled hydraulic brake device that controls an actuator in accordance with information input from the first control device 100 or the second control device 200 to transmit hydraulic pressure from a master cylinder to a cylinder.

The steering device 420 includes, for example, a steering ECU, and an electric motor.

The electric motor, for example, applies a force to a rack and pinion mechanism to change the direction of the steered wheels. The steering ECU drives an electric motor in accordance with information input from the first control device 100 or the second control device 200, or information input from a steering wheel of the driving operator 70, to change a direction of steerable wheels.

The camera 310 is, for example, a digital camera using a solid-state imaging element such as a CCD or CMOS. The camera 310 is attached at any location on the vehicle M. The camera 310 captures images of the surroundings of the vehicle M repeatedly, for example, periodically. The camera 310 may also be a stereo camera. Further, the camera 310 and the camera 10 may be the same camera.

The radar device 320 emits radio waves such as millimeter waves around the vehicle M and detects radio waves reflected by objects (reflected waves) to detect at least the position (distance and orientation) of the objects. The radar device 320 is attached at any location of the vehicle M. The radar device 320 may detect the position and speed of the object using a frequency modulated continuous wave (FM-CW) method.

### Switching Control Unit

The switching control unit 300 switches a travel control mode implemented by the first control device 100 and/or the second control device 200, and controls start and end of each travel control mode. In the embodiment, any one of a plurality of travel control modes including a first mode, a second mode, and a third mode is implemented. In the embodiment, the first mode and the third mode are implemented by the first control device 100, and the second mode is implemented by the second control device 200. Each of the first mode, the second mode, and the third mode may include automated driving. Automated driving refers to, for example, automatically controlling one or both of steering and speed of a vehicle to execute driving control (travel control). However, the plurality of travel control modes may include four or more travel control modes. For example, the plurality of travel control modes may include a manual driving mode in which no travel control is implemented by either the first control device 100 or the second control device 200. Further, the vehicle system 1 may be configured such that only two travel control modes, namely the first mode and the second mode, are executable.

The first mode is, for example, a mode that performs travel control toward a destination. The area in which activation of the first mode is permitted may be limited to a certain area (hereinafter referred to as a start-permissible area). The second mode is, for example, a mode that has an automation level lower than that of the first mode and performs travel control without considering a destination. The third mode is, for example, a mode that has an automation level lower than that of the first mode and higher than the automation level of the second mode and performs travel control without considering a destination. A higher automation degree may mean that a degree to which the vehicle system 1 controls the vehicle M is higher; in other words, a frequency or an amount of control with which the vehicle system 1 (more specifically, the first vehicle control unit 160 and/or the second vehicle control unit 230) controls the travel driving force output device 400, the brake device 410, and/or the steering device 420 is greater. Alternatively, a higher automation degree may mean that a degree to which a driver intervenes in control (driving operation) of the vehicle M is lower.

Further, the first mode may be a so-called hands-off mode in which gripping of the steering wheel 72 (a task of gripping the steering wheel 72) is not imposed on an occupant of the vehicle M. Further, in the first mode, a task of monitoring surroundings of the vehicle M (hereinafter referred to as surroundings monitoring) may also not be imposed on the occupant. Alternatively, in the first mode, surrounding monitoring of the vehicle M may be imposed on the occupant, while gripping of the steering wheel 72 may not be imposed.

Further, the second mode and the third mode may be so-called hands-on modes in which gripping of the steering wheel 72 is required for an occupant of the vehicle M. Further, in the second mode and the third mode, surroundings monitoring of the vehicle M may be imposed on the occupant.

Further, the first mode and the third mode may be modes in which various functions such as functions of an advanced driver assistance system (ADAS), a junction passing function, and a merging function are automatically executed based on a determination on a side of the vehicle system 1 without receiving an operation indicating an instruction or permission from an occupant (driver) via the second operation portion 48 or the like (regardless of presence or absence of an operation). The ADAS may include, for example, functions such as adaptive cruise control (ACC), lane keeping assistance system (LKAS), forward collision warning (FCW), collision mitigation braking system (CMBS), and auto lane changing assist (ALCA).

Specifically, the first mode may be a mode in which the above-described various functions are executed based on route setting to a destination by the navigation device 80. In other words, the first mode may be a mode (hereinafter referred to as a “navigation travel mode”) that performs travel control along a route calculated such that, when the vehicle proceeds to a point at which a plurality of route candidates exist, the vehicle M proceeds to a road leading toward the destination among the plurality of route candidates.

The third mode may be a mode in which automated driving is performed such that, when no destination is set, the vehicle travels along a road according to a route calculated based on predetermined route determination conditions. In other words, the third mode may be a mode (hereinafter referred to as a “road-following travel mode”) that performs travel control along a route calculated such that, when the vehicle proceeds to a point at which a plurality of route candidates exist, the vehicle M proceeds to a road determined based on a predetermined priority order among the plurality of route candidates. The mode may be a mode that performs travel control along a calculated route.

On the other hand, the second mode may be a mode in which various functions such as functions of an advanced driver assistance system (ADAS) are executed based on contents of an operation by receiving, via the second operation portion 48 or the like, an operation indicating an instruction or permission from an occupant (driver). Note that the second mode may be a mode in which a junction passing function and/or a merging function cannot be executed.

As illustrated in FIG. 2, the switching control unit 300 includes, for example, an acquisition unit 302, a determination unit 304, and the mode determination unit 306. The acquisition unit 302, the determination unit 304, and the mode determination unit 306 are each implemented, for example, by a hardware processor such as a central processing unit (CPU) executing a program (software). Some or all of these components may be implemented by hardware (including circuitry) such as a large scale integration (LSI), an application specific integrated circuit (ASIC), a field-programmable gate array (FPGA), a graphics processing unit (GPU), or a system on chip (SoC), or may be implemented by cooperation of software and hardware. The program may be stored in advance in a storage device (a storage device including a non-transitory storage medium) such as an HDD or a flash memory of the switching control unit 300, or may be stored in a removable storage medium such as a DVD or a CD-ROM and installed into the HDD or the flash memory of the switching control unit 300 when the storage medium (a non-transitory storage medium) is mounted in a drive device.

The acquisition unit 302 acquires, for example, detection results of the vehicle sensor 50 (for example, a GPS sensor), information acquired by the GNSS receiver 81, and the like. Further, the acquisition unit 302 acquires contents of operations by an occupant on the HMI 40 or the navigation HMI 82. The operation contents may include, for example, presence or absence of an operation on the first operation portion 46, designation of contents of travel control performed on the second operation portion 48, and information related to a destination input via the navigation HMI 82. Further, the acquisition unit 302 may acquire an image in which an occupant is captured, from the driver monitoring camera 60.

The determination unit 304 determines a position of the vehicle M based on, for example, information acquired by the acquisition unit 302. For example, the determination unit 304 determines whether the position of the vehicle M based on GPS or GNSS satisfies a predetermined condition. The predetermined condition may be, for example, whether the position of the vehicle M belongs to a start-permissible area of the first mode. In this case, the switching control unit 300 holds, in advance, information related to the start-permissible area in a storage device (not illustrated), and the determination unit 304 may perform the above determination based on the information. However, the predetermined condition may be changed as appropriate.

The mode determination unit 306 determines, based on, for example, information acquired by the acquisition unit 302 and a determination result by the determination unit 304, a travel control mode to be implemented by the first control device 100 and/or the second control device 200.

That is, the mode determination unit 306 changes a travel control mode to be executed when travel control is started by an occupant’s operation on the first operation portion 46, in accordance with a determination result of a position of the vehicle M by the determination unit 304. Accordingly, even in a case where the number of the first operation portion 46 (in other words, the number of operators included in the first operation portion 46) is smaller than the number of travel control modes, it becomes possible to change, according to a position of the vehicle M or the like, which of a plurality of travel control modes is preferentially started in response to the same operation. Therefore, the number of the first operation portion 46 can be reduced, and an appropriate travel control mode according to a position (scene) of the vehicle M can be started.

For example, in a state where a destination of the vehicle M is set and in a case where a position of the vehicle M satisfies a predetermined condition, the mode determination unit 306 executes (starts) the first mode by an operation on the first operation portion 46. For example, in a state where the destination of the vehicle M is set and in a case where the position of the vehicle M does not satisfy the predetermined condition, the mode determination unit 306 executes (starts) the second mode by an operation on the first operation portion 46. For example, in a state where the destination of the vehicle M is not set, the mode determination unit 306 executes (starts) the third mode regardless of the position of the vehicle M. Accordingly, in a case where a range in which travel control toward a destination can be executed (start-permissible range) is limited, it is possible to adjust a start priority order between travel control toward a destination and travel control performed without considering a destination. Further, in a case where a destination is set, by selectively using the first mode and the second mode, it is possible to suppress a misunderstanding by an occupant that control toward the destination has been started, even though the destination is set, when the third mode having a high assistance level and not considering the destination is executed. Further, in a case where a destination is not set, since the third mode is always executed regardless of the position of the vehicle M, travel control that is easy for an occupant to understand can be provided. Further, since a misunderstanding by an occupant that travel control toward a destination has been started does not occur in a case where no destination is set, by starting the third mode having an automation level higher than that of the second mode, travel control that further reduces an occupant’s burden compared with the second mode can be provided.

The mode determination unit 306 outputs a determined travel control mode to the first control device 100 and/or the second control device 200. For example, in a case where the travel control mode is determined to be the first mode or the third mode, the mode determination unit 306 outputs the determined travel control mode to the first control device 100, and in a case where the travel control mode is determined to be the second mode, outputs the determined travel control mode to the second control device 200. In a case where an operation on the second operation portion 48 is performed, the mode determination unit 306 may output contents of an occupant’s operation on the second operation portion 48 to the first control device 100 and/or the second control device 200.

Further, the mode determination unit 306 may change to a travel control mode having heavier tasks in a case where tasks associated with the determined travel control mode are not executed by a driver. For example, in a state where the first mode or the third mode is being executed, in a case where an occupant is in a posture in which a transition to manual driving cannot be made in response to a request from the system (for example, in a case where looking aside outside an allowable area is continuously performed, or in a case where a sign indicating difficulty in driving is detected), the mode determination unit 306 may prompt the occupant to transition to manual driving via the HMI 40. Further, in a case where a predetermined time elapses after the mode determination unit 306 prompts the occupant to transition to manual driving via the HMI 40 and the occupant does not respond, or in a case where the occupant is estimated not to be in a state of performing manual driving, it may perform control such as gradually decelerating the vehicle M while moving the vehicle M toward a target position (for example, a road shoulder) and stopping automated driving. After automated driving is stopped, the vehicle M enters a manual driving state, and it becomes possible to start the vehicle M by a manual operation by the occupant.

### First Control Device

Returning to FIG. 1, the first control device 100 includes, for example, a first recognition unit 120, a first control unit 140, the first vehicle control unit 160, and a storage unit 180. The first recognition unit 120, the first control unit 140, and the first vehicle control unit 160 are each implemented, for example, by a hardware processor such as a CPU executing a program (software). Some or all of these components may be implemented by hardware (including circuitry) such as an LSI, an ASIC, an FPGA, a GPU, or a SOC, or may be implemented by cooperation of software and hardware. The program may be stored in advance in a storage device (a storage device including a non-transitory storage medium) such as an HDD or a flash memory of the first control device 100, or may be stored in a removable storage medium such as a DVD or a CD-ROM and installed into the HDD or the flash memory of the first control device 100 when the storage medium (a non-transitory storage medium) is mounted in a drive device.

The storage unit 180 may be implemented by the above-described various storage devices, an electrically erasable programmable read-only memory (EEPROM), a read-only memory (ROM), a random-access memory (RAM), or the like. The storage unit 180 stores, for example, determination condition information 182, various types of information in the embodiment, programs, and the like. The determination condition information 182 includes, for example, information related to conditions for determining one of route candidates as a route in a case where a plurality of route candidates (travel path candidates) exist in a traveling direction of the vehicle M. Further, the storage unit 180 may store map information (for example, first map information 84 and second map information 92).

The first recognition unit 120 implements, in parallel, a function using artificial intelligence (AI) and a function using a model given in advance. For example, a function of “recognizing an intersection” may be realized by executing, in parallel, recognition of an intersection by deep learning or the like and recognition based on conditions given in advance (for example, presence of signals or road markings capable of pattern matching), and comprehensively evaluating both by assigning scores to both.

The first recognition unit 120 performs sensor fusion processing on detection results obtained by some or all of the camera 10 and the LIDAR unit 20 to recognize a surrounding situation of the vehicle M. The first recognition unit 120 may further perform sensor fusion processing using detection results of the camera 310 or the radar device 320.

For example, the first recognition unit 120 recognizes states such as a position (a relative position with respect to the vehicle M), a speed (a relative speed with respect to the vehicle M), and an acceleration of an object (for example, another vehicle or a pedestrian) present around the vehicle M (within a predetermined distance from the vehicle M). The position of the object, for example, is recognized as a position on absolute coordinates having a representative point of the vehicle M (a center of gravity, a drive shaft center, or the like) as the origin, and is used for control. The position of the object may be expressed by a representative point such as the center of gravity or a corner of the object, or may be expressed by an area. The “state” of the object may include acceleration or jerk of the object, or “a behavioral state” (for example, whether lane change is performed or to be performed). Further, the first recognition unit 120 may recognize a stop line, an obstacle, a red signal, a toll gate, and other road events.

Further, the first recognition unit 120 recognizes, for example, a lane (a traveling lane) in which the vehicle M travels.

Here, the first recognition unit 120 recognizes, for example, left and right lane markings as viewed with respect to the vehicle M (as viewed from the vehicle M) from images captured by the camera 10 (hereinafter referred to as camera images), and recognizes the traveling lane based on positions of the recognized lane markings. For example, the first recognition unit 120 analyzes the camera images, extracts edge points having a large luminance difference with adjacent pixels in the images, and connects the edge points to recognize lane markings on an image plane. Furthermore, the first recognition unit 120 converts positions of lane markings with reference to a position of a representative point of the vehicle M into a vehicle coordinate system, and recognizes, as a traveling lane, a lane defined by left and right lane markings closest to the vehicle M. The first recognition unit 120 may recognize adjacent lanes adjacent to the traveling lane based on the recognized lane markings. Further, the first recognition unit 120 may recognize the traveling lane by recognizing, not limited to lane markings, objects capable of specifying a lane position (roadway boundaries, road boundaries) including a road shoulder, a curb, a median strip, a guardrail, a fence, and a wall, based on analysis results of the camera images.

Further, the first recognition unit 120 may recognize lanes around the vehicle M including the traveling lane on which the vehicle M travels by referring to map information (for example, second map information 92) based on a position of the vehicle M detected by the vehicle sensor 50 or the GNSS receiver 81. In addition, the first recognition unit 120 may recognize lane markings defining the traveling lane, and may recognize adjacent lanes adjacent to the traveling lane and lane markings defining the adjacent lanes. Further, the first recognition unit 120 may recognize center lines (lane center lines) of the traveling lane and adjacent lanes from the map information. Further, the first recognition unit 120 may recognize lanes and lane markings around the vehicle M by combining lane and lane marking information acquired from the camera images with lane and lane marking information acquired from the map information.

Further, when recognizing the traveling lane, the first recognition unit 120 may recognize a position and a posture of the vehicle M with respect to the traveling lane. The first recognition unit 120, for example, may recognize the deviation of the reference point of the vehicle M from the center of the lane and an angle formed between a travel direction of the vehicle M and a line connected to the center of the lane as the relative position or posture of the vehicle M for the traveling lane. Alternatively, the first recognition unit 120 may recognize a position of the reference point of the vehicle M related to one side end portion (a road marking or a road boundary) of the traveling lane or the like as a relative position of the vehicle M related to the traveling lane.

Further, the first recognition unit 120 may recognize a road shape in a traveling direction of the vehicle M (for example, a straight road, a curved road, or an intersection), and whether a road shape having a plurality of route candidates exists within a predetermined distance in the traveling direction. Further, the first recognition unit 120 may recognize a road type around the vehicle M by referring to the map information. The road types include, for example, expressways, connection roads of expressways, primary arterial roads, secondary arterial roads, tertiary arterial roads, residential roads, and other general roads.

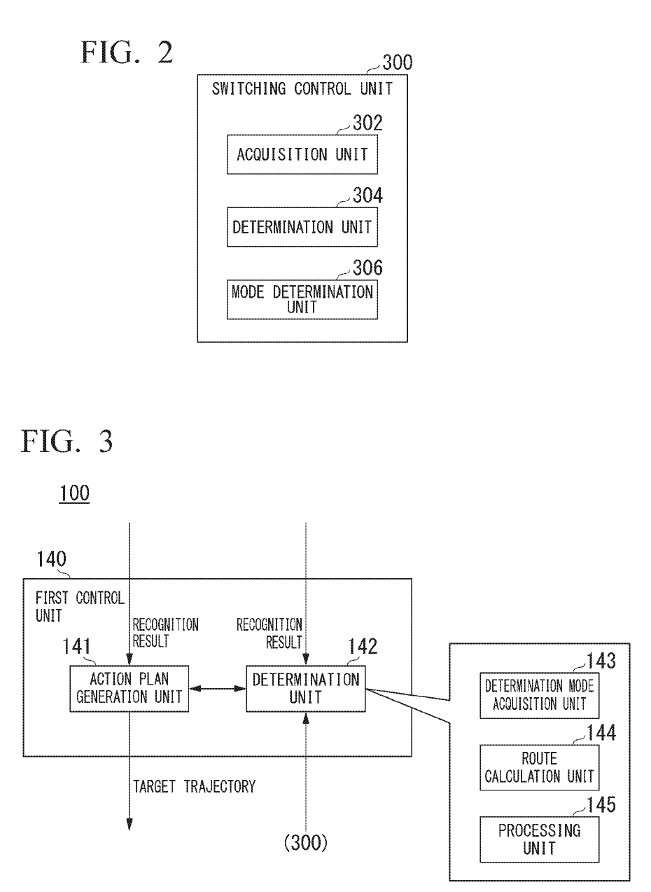

The first control unit 140 executes control to assist driving of an occupant (driver) based on recognition results by the first recognition unit 120 and information output from the switching control unit 300 (for example, information on a travel control mode). FIG. 3 is a functional configuration diagram of the first control unit 140. The first control unit 140 includes, for example, an action plan generation unit 141 and a determination unit 142.

In principle, the action plan generation unit 141 generates a target trajectory in which the vehicle M will automatically travel (without depending on an operation of the driver) in the future such that the vehicle M travels in a recommended lane determined by the recommended lane determination unit 91 and can also cope with surrounding situations of the vehicle M. For example, a target trajectory includes a speed factor. For example, the target trajectory is represented as a sequence of points (trajectory points) that the vehicle M should reach. The trajectory point is a point that the vehicle M should reach for a predetermined traveling distance (for example, a few meters) in terms of road distance, and in addition, the target speed and target acceleration are generated as part of the target trajectory for each predetermined sampling time (for example, a few tenths of a second). In addition, the trajectory point may be the position that the vehicle M should reach at each predetermined sampling time. In this case, information on the target speed and target acceleration is expressed as an interval between trajectory points.

The action plan generation unit 141 may set events (functions) of automated driving in generating a target trajectory. The events of automated driving include a constant-speed travel event, a low-speed following travel event, a lane change event, a branching event, a merging event, and an overtaking event. The action plan generation unit 141 generates a target trajectory according to a triggered event. Further, the action plan generation unit 141 generates the target trajectory so that travel control corresponding to contents determined by the mode determination unit 306 (that is, travel control based on the first mode or the third mode) can be executed.

The determination unit 142 includes, for example, a determination mode acquisition unit 143, a route calculation unit 144, and a processing unit 145. The determination mode acquisition unit 143 acquires information on a travel control mode determined by the mode determination unit 306.

The route calculation unit 144 calculates a route of the vehicle M according to a situation of the vehicle M based on, for example, a travel control mode acquired by the determination mode acquisition unit 143. For example, in the first mode (navigation travel mode), the route calculation unit 144 calculates a route such that the vehicle M proceeds toward a destination. Further, in the third mode (road-following travel mode), the route calculation unit 144 calculates, for each of points having a plurality of route candidates, a route such that the vehicle M proceeds to a road determined based on a predetermined priority order among the plurality of route candidates.

The priority order is determined, for example, based on determination condition information 182 stored in the storage unit 180. The determination condition information 182 may include, for example, information related to priorities based on road standards. However, contents of the determination condition information 182 are changeable as appropriate, and may include, for example, information related to a road width, or information related to a road rank based on comparison between a road on which the vehicle M travels when entering the point (hereinafter referred to as an “approach road”) and an intersecting road. Hereinafter, as an example, a case where the determination condition information 182 is information related to priorities based on road standards will be described.

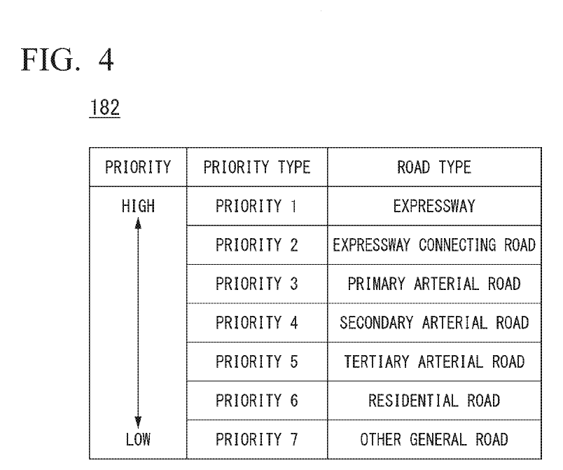

FIG. 4 is a diagram illustrating an example of the determination condition information 182. In the determination condition information 182 illustrated in FIG. 4, for example, a priority, a priority type, and a road type are associated with each other. The road type is information related to a road standard, and is information acquirable, for example, from map information (first map information 84 and second map information 92). In the example of FIG. 4, priorities 1 to 7 are assigned in descending order of priority, and a road type of “expressway” is associated with priority 1, a road type of “connection road of an expressway” is associated with priority 2, a road type of “primary arterial road” is associated with priority 3, a road type of “secondary arterial road” is associated with priority 4, a road type of “tertiary arterial road” is associated with priority 5, a road type of “residential road” is associated with priority 6, and a road type of “other general road” is associated with priority 7. Note that the number of priorities and road types assigned to each priority in the embodiment are not limited to the example of FIG. 4.

In the third mode (road-following travel mode), the route calculation unit 144 may calculate a route such that the vehicle M proceeds to a road having the highest priority (that is, the highest priority order) among a plurality of route candidates. For example, in a case where, at a certain point, there exist a road having a priority type of “priority 2,” a road having a priority type of “priority 3,” and a road having a priority type of “priority 6,” the route calculation unit 144 may calculate a route such that the vehicle M proceeds to the road having the priority type of “priority 2”.

Further, in the third mode (road-following travel mode), in a case where a priority (priority order) of a road extending straight ahead from an approach road (that is, a road continuing from the approach road; hereinafter referred to as a straight-ahead road) is equal to or greater than a predetermined value, the route calculation unit 144 may select the straight-ahead road as a route even in a case where an intersecting road has a higher priority than the straight-ahead road. Accordingly, it is possible to suppress a state in which right and left turns occur whenever an intersecting road exists. Therefore, it is possible to reduce a sense of discomfort of an occupant of the vehicle M, and to suppress a situation in which the vehicle M travels on an unintended higher-ranked road (such as an expressway) unintended by the occupant.

Returning to FIG. 3, the processing unit 145 executes various processes based on, for example, a route calculated by the route calculation unit 144. For example, the processing unit 145 causes the first control unit 140 to generate a target trajectory for causing the vehicle M to travel along the route calculated by the route calculation unit 144.

The first control unit 140 generates a target trajectory for causing the vehicle M to travel based on information determined by the determination unit 142 and recognition results of the first recognition unit 120.

Returning to FIG. 1, the first vehicle control unit 160 controls the travel driving force output device 400, the brake device 410, and the steering device 420 such that the vehicle M passes the target trajectory generated by the action plan generation unit 141 at scheduled times.

### Second Control Device

The second control device 200 includes, for example, a second recognition unit 210, a second control unit 220, and the second vehicle control unit 230. The second recognition unit 210, the second control unit 220, and the second vehicle control unit 230 are implemented, for example, by a hardware processor such as a CPU executing a program (software). Some or all of these components may be implemented by hardware (including circuitry) such as an LSI, an ASIC, an FPGA, a GPU, or a SoC, or may be implemented by cooperation of software and hardware. The program may be stored in advance in a storage device (a storage device including a non-transitory storage medium) such as an HDD or a flash memory of the second control device 200, or may be stored in a removable storage medium such as a DVD or a CD-ROM and installed into the HDD or the flash memory of the second control device 200 when the storage medium (a non-transitory storage medium) is mounted in a drive device.

The second recognition unit 210 performs sensor fusion processing on detection results obtained by some or all of the camera 310 and the radar device 320, and recognizes the surrounding situations of the vehicle M.

For example, the second recognition unit 210 recognizes positions, types, speeds, and the like of objects existing around the vehicle M (within a predetermined distance) based on results of the sensor fusion processing. The second recognition unit 210 may have functions similar to those of the first recognition unit 120. The second recognition unit 210 may use detection results of the camera 10 or the LIDAR unit 20 for the sensor fusion processing.

The second recognition unit 210 may be omitted, and processing results of the above-described first recognition unit 120 may be used.

The second control unit 220 executes control for assisting driving of an occupant (driver) based on recognition results by the second recognition unit 210. In a case where the travel control mode is determined to be the second mode by the mode determination unit 306, the second control unit 220 executes travel control of the vehicle M based on the second mode. For example, the second control unit 220 executes ADAS functions according to operations performed by the occupant on the second operation portion 48. For example, the second control unit 220 executes ADAS functions by generating a target trajectory along which the vehicle M will travel in the future based on a travel state of the vehicle M (a position and a speed of the vehicle M) and surrounding situations (road conditions, positions of surrounding objects, or the like).

The second vehicle control unit 230, for example, acquires information on a target trajectory (trajectory points) generated by the second control unit 220 and stores the information in a memory (not illustrated). The second vehicle control unit 230 controls the travel driving force output device 400 and the brake device 410 based on speed elements associated with the target trajectory stored in the memory. The second vehicle control unit 230 controls the steering device 420 according to a curvature of the target trajectory stored in the memory. Processing of the second vehicle control unit 230 is realized, for example, by a combination of feedforward control and feedback control. As an example, the second vehicle control unit 230 executes control by combining feedforward control according to a curvature of a road ahead of the vehicle M and feedback control based on deviation from the target trajectory.

### Regarding Travel Scenes

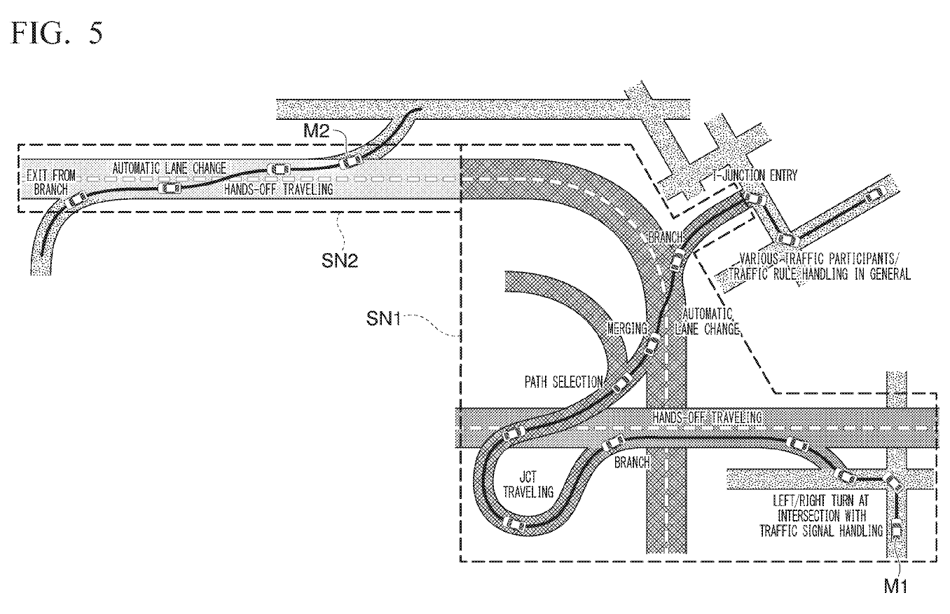

Here, road conditions (travel scenes) in which the above-described first mode, second mode, and third mode are executed will be specifically described. FIG. 5 is a diagram for illustrating travel scenes in which the first mode, the second mode, and the third mode are executable (start-permissible). In the example of FIG. 5, a first travel scene SN1 and a second travel scene SN2 are illustrated. In addition, in the example of FIG. 5, an example of driving control of a vehicle M1 traveling in the first travel scene SN1 and an example of driving control of a vehicle M2 traveling in the second travel scene SN2 are illustrated together with travel trajectories of the vehicles M1 and M2. In the example of FIG. 5, a road in the first travel scene SN1 is a general road in an urban area (for example, a main arterial road of a general road), and a road in the second travel scene SN2 is an expressway. However, road conditions are not limited thereto. For example, an expressway may be included in the first travel scene SN1 at a connection portion between the first travel scene SN1 and the second travel scene SN2. Roads other than the first travel scene SN1 and the second travel scene SN2 may be, for example, narrow streets, but are not particularly limited. The switching control unit 300 distinguishes, based on road conditions on which the vehicle M travels as illustrated in FIG. 5, a start-permissible area (execution-permissible area) of the first mode, a start-permissible area (execution-permissible area) of the second mode, and a start-permissible area (execution-permissible area) of the third mode.

In the example of FIG. 5, both the first travel scene SN1 and the second travel scene SN2 are areas (scenes) in which all of the first mode, the second mode, and the third mode are executable (start-permissible). On the other hand, roads other than the first travel scene SN1 and the second travel scene SN2 are areas (scenes) in which the first mode is not executable (not start-permissible) and the second mode and the third mode are executable (start-permissible). That is, in the example of FIG. 5, the start-permissible area of the first mode includes the first travel scene SN1 and the second travel scene SN2. In other words, the start-permissible area of the first mode is narrower than the start-permissible area of the second mode and is narrower than the start-permissible area of the third mode. For each of the first mode, the second mode, and the third mode, start-permissible areas may be determined by the vehicle system 1 (for example, the determination unit 304 or the like) based on map information (for example, the first map information 84 and the second map information 92).

### Processing Flow

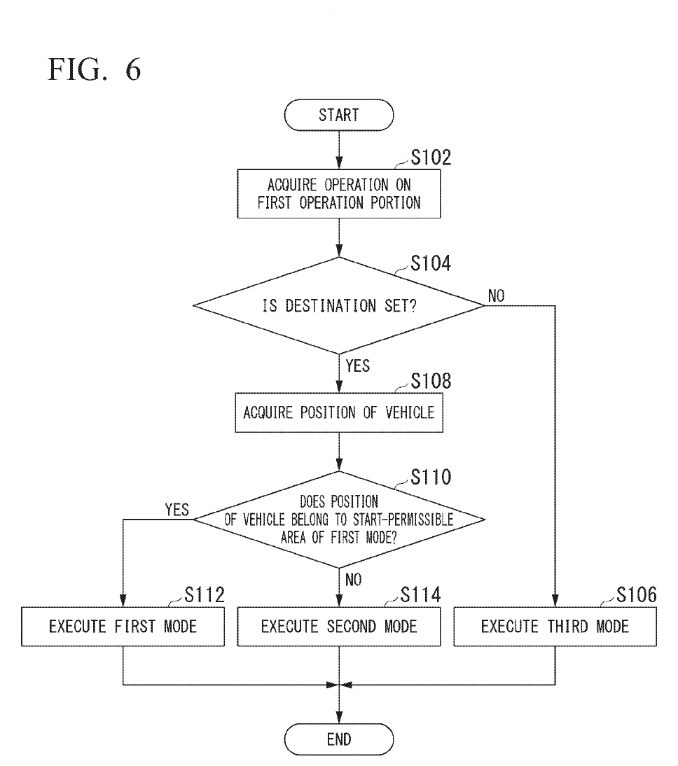

Hereinafter, processing executed by the vehicle system 1 according to the embodiment will be described. FIG. 6 is a flowchart illustrating an example of a flow of processing executed by the vehicle system 1. Hereinafter, among processes executed by the vehicle system 1, description will be mainly given focusing on a processing in which an occupant starts (executes) travel control by operating the first operation portion 46. Further, at a start of the processing, it is assumed that travel control based on none of the first mode, the second mode, or the third mode is being executed.

In the example of FIG. 6, the acquisition unit 302 acquires an operation on the first operation portion 46 by an occupant of the vehicle M (step S102). After one operation on the first operation portion 46 is acquired, the mode determination unit 306 determines whether a destination of the vehicle M is set (step S104). In a case where it is determined that the destination of the vehicle M is not set (step S104; NO), the mode determination unit 306 determines the third mode and executes (starts) the third mode (step S106). With this, the processing of the present flowchart ends.

In a case where it is determined that a destination of the vehicle M is set (step S104; YES), the acquisition unit 302 acquires a position of the vehicle M (step S108). Next, the determination unit 304 determines whether the position of the vehicle M belongs to a start-permissible area of the first mode (step S110). In a case where it is determined that the position of the vehicle M belongs to the start-permissible area of the first mode (step S110; YES), the mode determination unit 306 determines the first mode and executes (starts) the first mode (step S112). In a case where it is determined that the position of the vehicle M does not belong to the start-permissible area of the first mode (step S110; NO), the mode determination unit 306 determines the second mode and executes (starts) the second mode (step S114). By performing the processing of step S112 or step S114, the processing of this flowchart ends.

According to the above-described embodiment, a travel control device (the first control device 100, the second control device 200, the switching control unit 300, the HMI 40, the driving operator 70, the navigation device 80, and the MPU 90) includes, in performing travel control of the vehicle M, a travel control unit (the first control device 100, the second control device 200, and the mode determination unit 306) configured to be capable of executing a plurality of travel control modes including a first mode and a second mode that performs travel control having an automation level lower than that of the first mode, a start operation portion (the first operation portion 46) that starts travel control by the travel control unit, and a determination unit 304 that determines a position of the vehicle M, in which the travel control unit changes a travel control mode to be executed when travel control is started by an operation on the start operation portion according to a determination result by the determination unit 304. Accordingly, an effective travel control mode corresponding to a scene can be easily started. Thus, it is possible to contribute to development of a sustainable transportation system.

The embodiment described above can be expressed as below.

A travel control device including

a storage medium storing computer-readable instructions, and

a processor connected to the storage medium, in which

the processor executes the computer-readable instructions to:

start travel control of a vehicle based on any one of a plurality of travel control modes including a first mode and a second mode that performs travel control having an automation level lower than that of the first mode, by an operation on a start operation portion, and,

in starting the travel control,

determine a position of the vehicle, and

change a travel control mode to be executed when the travel control is started by the operation on the start operation portion according to a determination result of the position.

### Modification Examples

In a case where the first operation portion 46 is operated a plurality of times, the travel control unit may execute, among the plurality of travel control modes, a travel control mode different from a travel control mode executed before the first operation portion 46 is operated the plurality of times. In this case, the first operation portion 46 also functions to accept an occupant operation for switching travel control modes. For example, a transition order of the plurality of travel control modes may be set in advance. In a case where the first operation portion 46 is operated only once, a travel control mode to be started is determined as in the above embodiment, and in a case where the first operation portion 46 is operated a plurality of times, a travel control mode to be started may be determined based on the above transition order starting from the travel control mode started when the first operation portion 46 is operated only once. For example, in a case where the plurality of travel control modes include only the first mode and the second mode, and the vehicle M belongs to the start-permissible range of the first mode, in a case where the first operation portion 46 is operated once, the first mode is started, and in a case where the first operation portion 46 is operated twice, the second mode different from the currently executed first mode may be started. Accordingly, a travel control mode that is deprioritized based on the position of the vehicle M or the like can also be started by operating the first operation portion 46 a plurality of times.

Further, the travel control unit may allow an occupant of the vehicle M to set which of the plurality of travel control modes is to be preferentially executed (for example, whether the first mode or the second mode is to be preferentially executed) via, for example, the HMI 40. In a case where such a setting is made by the occupant of the vehicle M, the vehicle system 1 may preferentially execute the travel control mode set by the occupant regardless of a determination result by the determination unit 304. Accordingly, an occupant’s setting (customization) can be prioritized.

Further, the travel control unit may be capable of adding executable travel control modes by an update via, for example, the communication device 30. In a case where executable travel control modes are added by such an update, the travel control unit may preferentially execute the added travel control mode. Accordingly, since the latest function is preferentially started, it becomes possible to select and start a travel control mode having higher performance, or to allow an occupant to preferentially experience the latest function.

Further, in the above-described embodiment, whether the position of the vehicle M acquired using GPS, GNSS, or the like belongs to the start-permissible range of the first mode is determined; however, the content of determination of the position of the vehicle M is not limited thereto. For example, determination may be performed based on a speed limit of a road on which the vehicle M is traveling. More specifically, for example, based on the speed limit of the road on which the vehicle M is traveling, a size of the road (such as a road width or a road standard) may be estimated, and whether the first mode is executable may be determined. The speed limit may be acquired, for example, from map information (the first map information 84 and the second map information 92), or may be acquired by recognizing a road sign through image recognition. Alternatively, determination may be performed based on the number of lanes or a lane width of the road on which the vehicle M is traveling. More specifically, for example, based on the number of lanes or the lane width of the road on which the vehicle M is traveling, a size of the road (such as a road width or a road standard) may be estimated, and whether the first mode is executable may be determined. The number of lanes and the lane width may be acquired, for example, from map information, or may be acquired by image recognition of the road. These determination conditions are examples of the “predetermined condition” in determination of the position of the vehicle M performed by the determination unit 304.

Further, in the above-described embodiment, the third mode is executed in a case where a destination of the vehicle M is not set; however, it is not limited thereto. In a case where a destination of the vehicle M is not set, the travel control unit may execute the second mode regardless of the position of the vehicle M. In a case where a destination is not set, there is no need to execute travel control corresponding to a destination (the first mode), and with such a configuration, the second mode can always be prioritized regardless of the position of the vehicle M.

Further, in the above-described embodiment, it has been described that the third mode is a road-following travel mode; however, the second mode may be a road-following travel mode. As long as the second mode has an automation level lower than that of the first mode, specific contents of the second mode can be appropriately changed. Similarly, as long as the third mode has an automation level lower than that of the first mode and higher than the automation level of the second mode, specific contents of the third mode can also be appropriately changed. In the above-described embodiment, since grasping of the steering wheel 72 and monitoring of surroundings of the vehicle M are imposed on an occupant in the third mode, and these are not imposed on an occupant in the first mode, it can be considered that the third mode is a mode having an automation level lower than that of the first mode.

As above, although a form for performing the present invention has been described using the embodiment, the present invention is not limited to such an embodiment at all, and various modifications and substitutions can be applied within a range not departing from the concept of the present invention.

What is claimed is:

1. A travel control device comprising:
a storage medium storing computer-readable instructions; and
one or more processors connected to the storage medium, the processor executing the computer-readable instructions to:
start travel control of a vehicle based on any one of a plurality of travel control modes including a first mode and a second mode that performs travel control having an automation level lower than the automation level of the first mode, by an operation on a start operation portion;
determine a position of the vehicle in starting the travel control; and
change, in starting the travel control, a travel control mode to be executed when the travel control is started by an operation on the start operation portion according to a determination result of the position.

2. The travel control device according to claim 1,
wherein the one or more processors execute the computer-readable instructions to:
in a case where the start operation portion is operated a plurality of times, execute, among the plurality of travel control modes, a travel control mode different from a travel control mode executed before the start operation portion is operated the plurality of times.

3. The travel control device according to claim 1,
wherein the one or more processors execute the computer-readable instructions to:
in a case where whether the first mode or the second mode is to be preferentially executed is set by an occupant of the vehicle, preferentially execute the travel control mode set by the occupant regardless of the determination result.

4. The travel control device according to claim 1,
wherein the one or more processors execute the computer-readable instructions to:
in a case where a travel control mode executable by the travel control unit is added by an update, preferentially execute the added travel control mode.

5. The travel control device according to claim 1, wherein
the first mode is a mode that performs travel control toward a destination,
the second mode is a mode that performs travel control without considering a destination, and
the one or more processors execute the computer-readable instructions to:
in a state where a destination of the vehicle is set,
execute the first mode by an operation on the start operation portion in a case where the position satisfies a predetermined condition, and
execute the second mode by an operation on the start operation portion in a case where the position does not satisfy the predetermined condition.

6. The travel control device according to claim 5,
wherein the one or more processors execute the computer-readable instructions to:
in a state where a destination of the vehicle is not set, execute the second mode regardless of the position.

7. The travel control device according to claim 1, wherein
the first mode is a mode that performs travel control toward a destination,
the second mode is a mode that performs travel control without considering a destination,
the plurality of travel control modes further include a third mode that has an automation level lower than the automation level of the first mode and higher than the automation level of the second mode and performs travel control without considering a destination, and
the one or more processors execute the computer-readable instructions to:
execute the first mode by an operation on the start operation portion in a case where, in a state where a destination of the vehicle is set, the position satisfies a predetermined condition,
execute the second mode by an operation on the start operation portion in a case where, in a state where the destination of the vehicle is set, the position does not satisfy the predetermined condition, and
execute the third mode in a state where the destination of the vehicle is not set.

8. The travel control device according to claim 1, wherein
the first mode is a mode that performs travel control toward a destination,
the second mode is a mode that performs travel control without considering a destination,
the plurality of travel control modes further include a third mode that has an automation level higher than the automation level of the second mode and performs travel control without considering a destination,
the third mode is a mode that performs travel control along a route calculated such that, when the vehicle proceeds to a point at which a plurality of route candidates exist, the vehicle proceeds to a road determined based on a predetermined priority order among the plurality of route candidates, and
the one or more processors execute the computer-readable instructions to:
execute the first mode by an operation on the start operation portion in a case where, in a state where a destination of the vehicle is set, the position satisfies a predetermined condition,
execute the second mode by an operation on the start operation portion in a case where, in a state where the destination of the vehicle is set, the position does not satisfy the predetermined condition, and
execute the third mode in a state where the destination of the vehicle is not set.

9. The travel control device according to claim 1, wherein
the first mode is a mode in which gripping of a steering wheel is not required for an occupant of the vehicle, and
the second mode is a mode in which gripping of the steering wheel is required for the occupant of the vehicle.

10. A travel control method executed by a computer, the travel control method comprising:
starting travel control of a vehicle based on any one of a plurality of travel control modes including a first mode and a second mode that performs travel control having an automation level lower than the automation level of the first mode, by an operation on a start operation portion;
determining a position of the vehicle in starting the travel control; and
changing, in starting the travel control, a travel control mode to be executed when the travel control is started by the operation on the start operation portion according to a determination result of the position.

11. A computer-readable non-transitory storage medium storing a program, the program causing a computer to:
start travel control of a vehicle based on any one of a plurality of travel control modes including a first mode and a second mode that performs travel control having an automation level lower than the automation level of the first mode, by an operation on a start operation portion;
determine a position of the vehicle in starting the travel control; and
change, in starting the travel control, a travel control mode to be executed when the travel control is started by the operation on the start operation portion according to a determination result of the position.
